(19) United States
(12) Patent Application Publication
(10) Pub. No.: US 2014/0309846 A1
(43) Pub. Date: Oct. 16, 2014

(54) METHOD FOR PREDICTING A BLEED AIR SYSTEM FAULT

(71) Applicant: GE Aviation Systems Limited, Cheltenham (GB)

(72) Inventor: Julia Ann Howard, Lee-On-The-Solent (GB)

(73) Assignee: GE Aviation Systems Limited, Cheltenham (GB)

(21) Appl. No.: 14/254,125

(22) Filed: Apr. 16, 2014

(30) Foreign Application Priority Data
Apr. 16, 2013 (GB) 13068697

(51) Int. Cl. B64F 5/00

(52) U.S. Cl. CPC B64F 5/0045
USPC 701/31.9

(57) ABSTRACT

A method of predicting a bleed air system fault in an aircraft having an engine operably coupled to a bleed air system including at least one valve, at least one bleed air system sensor, where the method includes receiving a sensor signal from the at least one of the bleed air system sensor to define a sensor output, comparing the sensor output to a reference value, and predicting a fault in the bleed air system based on the comparison.

### CROSS-REFERENCE TO RELATED APPLICATIONS

This application claims priority under 35 U.S.C. §119 to British Patent Application No. 13068697, filed Apr. 16, 2013, the disclosure of which is incorporated herein by reference in its entirety.

### BACKGROUND OF THE INVENTION

Contemporary aircraft include bleed air systems that take hot air from the engines of the aircraft for use in other systems on the aircraft including air conditioning and pressurization. Currently, airlines and maintenance personnel wait until a fault or problem occurs with the system and then attempt to identify the cause and fix it either during scheduled or, more likely, unscheduled maintenance. Some fault occurrences may also be recorded manually based on pilot discretion.

### BRIEF DESCRIPTION OF THE INVENTION

In one embodiment, the invention relates to a method of predicting a bleed air system fault in an aircraft having an engine operably coupled to a bleed air system including at least one valve, at least one bleed air system sensor, the method includes receiving a sensor signal from the at least one of the bleed air system sensor to define a sensor output, comparing the sensor output to a reference value for the sensor output, predicting a fault in the bleed air system based on the comparison, and providing an indication of the predicted fault.

### BRIEF DESCRIPTION OF THE DRAWINGS

In the drawings:

FIG. 1 is a schematic view of a portion of an exemplary bleed air system;

FIG. 2 is a perspective view of an aircraft and a ground system in which embodiments of the invention may be implemented; and

FIG. 3 is a flowchart showing a method of predicting a bleed air system fault in an aircraft according to an embodiment of the invention.

### DESCRIPTION OF EMBODIMENTS OF THE INVENTION

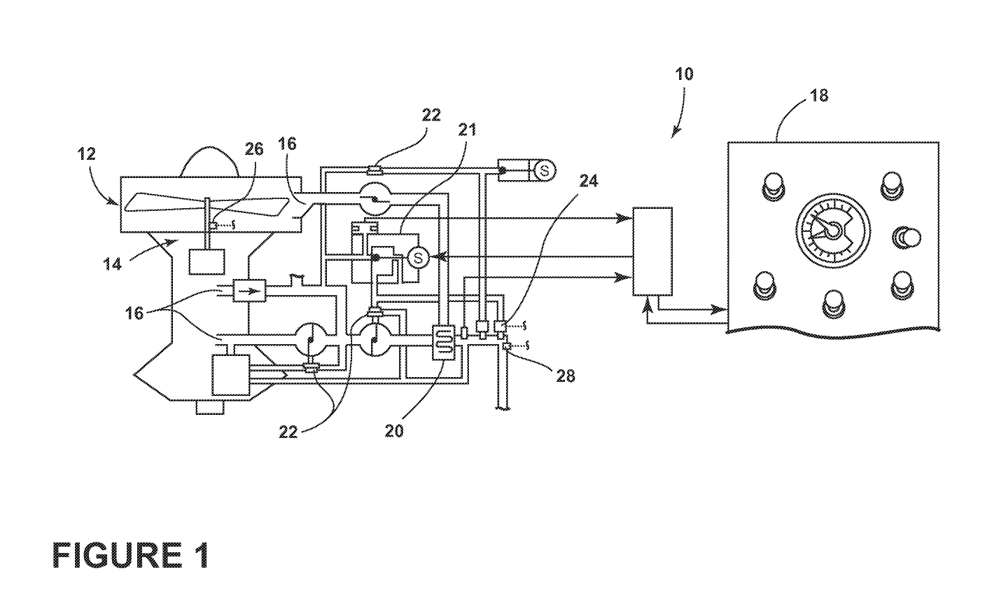

FIG. 1 schematically depicts a portion of a bleed air system 10, which is connected to an engine 12 having a fan 14, such as a turbofan jet engine. Various bleed ports 16 may be connected to various portions of the engine 12 to provide highly compressed air to the bleed air system 10. A control mechanism 18 may be utilized to control the bleed air system 10. Various components may be included in the bleed air system 10 including a pre-cooler 20, bleed air regulator 21, various valves 22 including a pre-cooler control valve, and various sensors including, for example, a temperature sensor 24, a fan speed sensor 26, and a pressure sensor 28. In the illustrated example, the temperature sensor 24 and the pressure sensor 28 are located after the pre-cooler valve. While only a single temperature sensor 24 and pressure sensor 28 have been illustrated it will be understood that any number of sensors may be included in the bleed air system 10 including that the sensors may be included at various stages in the bleed air system 10. Further, sensors may be included to output various parameters including binary flags for indicating valve settings and/or positions including for example the state of the valve (e.g. fully open, open, in transition, closed, fully closed); binary flags may also indicate a number of other items for example if a leak has been detected from the air system on the wing or if a temperature or pressure has been calculated by the aircraft to have exceeded a limit on a single occasion or multiple times over a specified time/data period. It is possible these data flags might be available from points in the system where continuous data is not currently available and as such might aid in predicting faults.

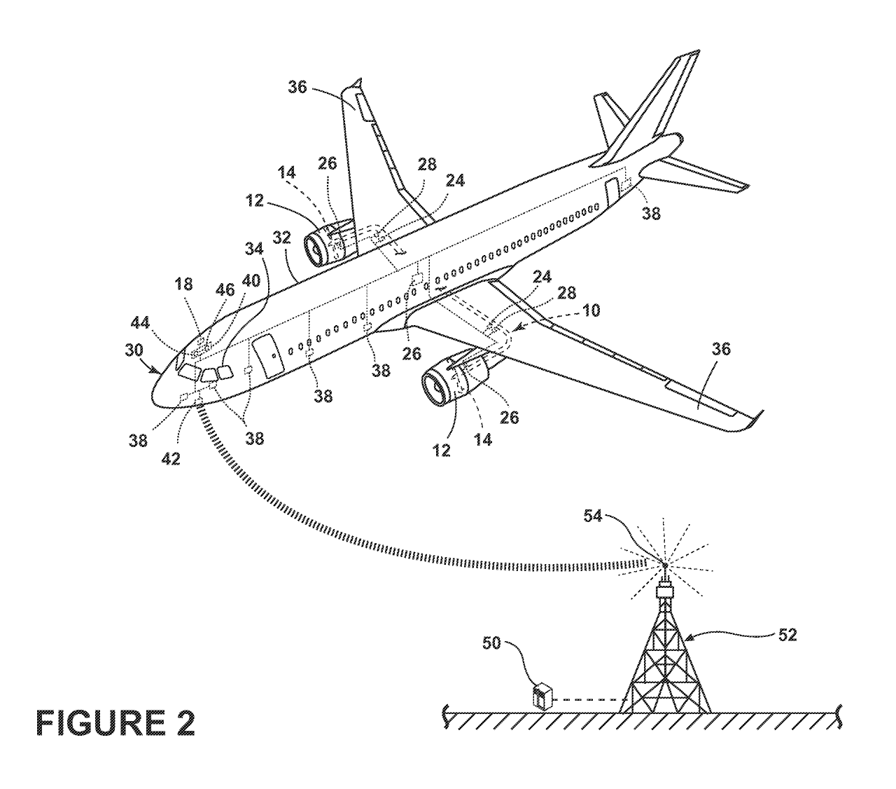

FIG. 2 illustrates an aircraft 30 that may include the bleed air system 10, only a portion of which has been illustrated for clarity purposes, and may execute embodiments of the invention. As illustrated the aircraft 30 may include multiple engines 12 coupled to a fuselage 32, a cockpit 34 positioned in the fuselage 32, and wing assemblies 36 extending outward from the fuselage 32. The control mechanism 18 has been illustrated as being included in the cockpit 34 and may be operated by a pilot located therein.

A plurality of additional aircraft systems 38 that enable proper operation of the aircraft 30 may also be included in the aircraft 30 as well as a controller 40, and a communication system having a wireless communication link 42. The controller 40 may be operably coupled to the plurality of aircraft systems 38 including the bleed air system 10. For example, the pre-cooler 20 (FIG. 1), bleed air regulator 21 (FIG. 1), various valves 22 (FIG. 1), a temperature sensor 24, fan speed sensor 26, and pressure sensor 28 may be operably coupled to the controller 40.

The controller 40 may also be connected with other controllers of the aircraft 30. The controller 40 may include memory 44, the memory 44 may include random access memory (RAM), read-only memory (ROM), flash memory, or one or more different types of portable electronic memory, such as discs, DVDs, CD-ROMs, etc., or any suitable combination of these types of memory. The controller 40 may include one or more processors 46, which may be running any suitable programs. The controller 40 may be a portion of an FMS or may be operably coupled to the FMS.

A computer searchable database of information may be stored in the memory 44 and accessible by the processor 46. The processor 46 may run a set of executable instructions to display the database or access the database. Alternatively, the controller 40 may be operably coupled to a database of information. For example, such a database may be stored on an alternative computer or controller. It will be understood that the database may be any suitable database, including a single database having multiple sets of data, multiple discrete databases linked together, or even a simple table of data. It is contemplated that the database may incorporate a number of databases or that the database may actually be a number of separate databases.

The database may store data that may include historical data related to the reference value for the sensor outputs as well as historical bleed air system data for the aircraft 30 and related to a fleet of aircraft. The database may also include reference values including historic values or aggregated values.

Alternatively, it is contemplated that the database may be separate from the controller 40 but may be in communication with the controller 40 such that it may be accessed by either the controller 40. For example, it is contemplated that the database may be contained on a portable memory device and in such a case, the aircraft 30 may include a port for receiving the portable memory device and such a port would be in electronic communication with controller 40 such that controller 40 may be able to read the contents of the portable memory device. It is also contemplated that the database may be updated through the wireless communication link 42 and that in this manner, real time information may be included in the database and may be accessed by the controller 40.

Further, it is contemplated that such a database may be located off the aircraft 30 at a location such as airline operation center, flight operations department control, or another location. The controller 40 may be operably coupled to a wireless network over which the database information may be provided to the controller 40.

While a commercial aircraft has been illustrated, it is contemplated that portions of the embodiments of the invention may be implemented anywhere including in a controller or computer 50 at a ground system 52. Furthermore, the database(s) as described above may also be located in a destination server or a computer 50, which may be located at and include the designated ground system 52. Alternatively, the database may be located at an alternative ground location. The ground system 52 may communicate with other devices including the controller 40 and databases located remote from the computer 50 via a wireless communication link 54. The ground system 52 may be any type of communicating ground system 52 such as an airline control or flight operations department.

One of the controller 40 and the computer 50 may include all or a portion of a computer program having an executable instruction set for predicting a bleed air system fault in the aircraft 30. Such predicted faults may include improper operation of components as well as failure of components. As used herein the term predicting refers to a forward looking determination that makes the fault known in advance of when the fault occurs and contrasts with detecting or diagnosing, which would be a determination after the fault has occurred. Regardless of whether the controller 40 or the computer 50 runs the program for predicting the fault, the program may include a computer program product that may include machine-readable media for carrying or having machine-executable instructions or data structures stored thereon. Such machine-readable media may be any available media, which can be accessed by a general purpose or special purpose computer or other machine with a processor. Generally, such a computer program may include routines, programs, objects, components, data structures, algorithms, etc. that have the technical effect of performing particular tasks or implementing particular abstract data types. Machine-executable instructions, associated data structures, and programs represent examples of program code for executing the exchange of information as disclosed herein. Machine-executable instructions may include, for example, instructions and data, which cause a general purpose computer, special purpose computer, or special purpose processing machine to perform a certain function or group of functions.

It will be understood that the aircraft 30 and the computer 50 merely represent two exemplary embodiments that may be configured to implement embodiments or portions of embodiments of the invention. During operation, either the aircraft 30 and/or the computer 50 may predict a bleed air system fault. By way of non-limiting example, while the aircraft 30 is being operated the control mechanism 18 may be utilized to operate the bleed air system 10. Sensors including the temperature sensor 24, fan speed sensor 26, and pressure sensor 28 may output data relevant to various characteristics of the bleed air system 10.

The controller 40 and/or the computer 50 may utilize inputs from the control mechanism 18, the temperature sensor 24, fan speed sensor 26, pressure sensor 28, aircraft systems 38, the database(s), and/or information from airline control or flight operations department to predict the bleed air system fault. Among other things, the controller 40 and/or the computer 50 may analyze the data output by the temperature sensor 24, fan speed sensor 26, and pressure sensor 28 over time to determine drifts, trends, steps, or spikes in the operation of the bleed air system 10. Such anomalies in the data may be too subtle on a day-to-day comparison to make such predictions of fault. The controller 40 and/or the computer 50 may also analyze the bleed air system data to determine historic median pressures, recent median pressures, historic median temperatures, recent median temperatures, historic standard deviation temperatures, recent standard deviation temperatures, maximum temperature over a given number of data points, maximum temperatures above a given threshold, pressure differences between the two engines on the aircraft 30, temperature differences between two engines on the aircraft 30, and to determine faults in the bleed air system 10 based thereon. Once a bleed air system fault has been predicted an indication may be provided on the aircraft 30 and/or at the ground system 52. It is contemplated that the prediction of the bleed air system fault may be done during flight, may be done post flight, or may be done after any number of flights. The wireless communication link 42 and the wireless communication link 54 may both be utilized to transmit data such that the fault may be predicted by either the controller 40 and/or the computer 50.

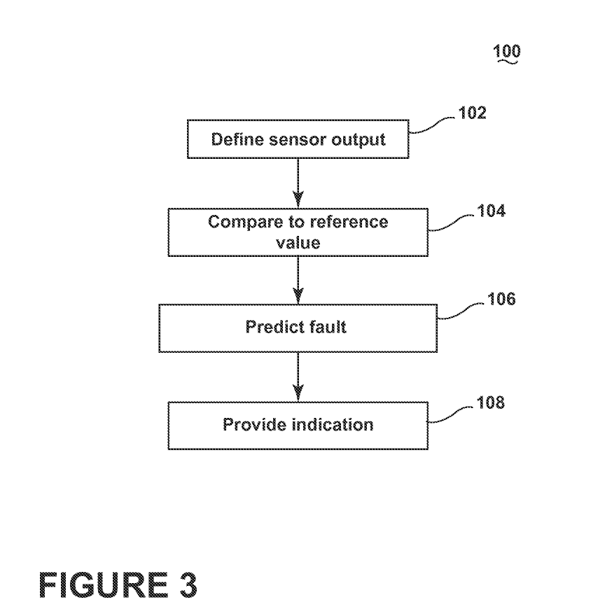

In accordance with an embodiment of the invention, FIG. 3 illustrates a method 100, which may be used for predicting a fault in the bleed air system 10 such a predicted fault may include a predicted failure. The method 100 begins at 102 by receiving a sensor signal from at least one of the bleed air system 10 sensors to define a sensor output relevant to a characteristic of the bleed air system 10. This may include sequentially and/or simultaneously receiving data from one or more of the sensors in the aircraft 30 including that a temperature sensor output may be received from the temperature sensor 24, a pressure sensor output indicative of the air pressure of the bleed air system 10 may be received from the pressure sensor 28, and fan speed output indicative of a fan speed of the engine may be received from the fan speed sensor 26. Furthermore, receiving the sensor signal may include receiving multiple sensor outputs and information regarding the settings of the various valves 22.

It is contemplated that the senor output may include raw data from which a variety of other information may be derived or otherwise extracted to define the sensor output. For example, a correlation may be calculated from the sensor signal and the engine fan speed and such a calculated value may form the sensor output. It will be understood that regardless of whether the sensor output is received directly or derived from received output, the output may be considered to be sensor output.

For example, the sensor output may be aggregated over time to define aggregated sensor data. Aggregating the received sensor output over time may include aggregating the received sensor output over multiple phases of flight and/or over multiple flights. Such aggregated sensor data may include a median value, a running or current median value, or a historical median value. It is also contemplated that aggregating the received sensor output may include aggregating multiple values including a current median value and a historical median value. Such aggregated sensor data may be reset after a maintenance event. By way of non-limiting examples, such aggregated sensor data may include a running historic median pressure value, a running recent median pressure value, a running historic median temperature value, a running recent median temperature value, a historic standard deviation temperature value, a recent standard deviation temperature value, a maximum temperature over a given number of data points, etc.

The sensor output may be received once per flight or multiple times per flight. The data may be received during a number of different phases of flight of the aircraft 30. For example, the multiple phases of flight may include taxi, both before takeoff and after landing, and the longest cruise segment. For example, the received sensor output may be one of a median sensor output calculated from sensor output received from the multiple phases.

At 104, the sensor output may be compared to a reference value for the sensor output. The reference value may be any suitable reference value related to the sensor output including that the reference value may be a temperature value, a value indicative of temperature values or pressure values at a specific fan speed, a pressure value, etc. The reference value for the sensor output may also include a historical reference value for the sensor output including for example historical data related to the bleed air system of the aircraft or historical data for multiple other aircraft. Thus, the output signal may be compared to results obtained from previous flights for the same aircraft and against the whole fleet of aircraft. Furthermore, the reference value for the sensor output may include a value that has been determined during flight such as by receiving an output of one of the temperature sensor 24, fan speed sensor 26, and pressure sensor 28. In this manner, it will be understood that the reference value for the sensor output may be defined during operation. For example, the reference value could be a pressure calculated from another engine of the aircraft. Alternatively, the reference values may be stored in one of the database(s) as described above.

In this manner, the sensor output may be compared to a reference value for the sensor output. Any suitable comparison may be made. For example, the comparison may include determining a difference between the sensor output and the reference value. By way of non-limiting example, the comparison may include comparing a recent signal output to a historic value. In the instance where the received sensor output is aggregated over time the comparison may include comparing the aggregated sensor data to the reference value. For example, from the comparison it may be determined if the aggregated sensor output satisfies a threshold value. By way of further example, this may include comparing historic median pressures to recent median pressures, comparing historic median temperatures to recent median temperatures, comparing historic standard deviation temperatures to recent standard deviation temperatures, etc. The comparison may alternatively include comparing a maximum temperature over a given number of data points to a reference value. The comparison may include determining a measure of maximum temperature above a given threshold. The comparison may alternatively include determining a pressure difference between engines on the same aircraft 30. Comparisons may be made on a per flight basis or the data may be processed per individual engine over a series of flights. It is also contemplated that comparisons may be limited to being within various indicated fan speed ranges due to dependency of temperature variation on the indicated fan speed.

At 106, a fault in the bleed air system may be predicted based on the comparison at 104. For example, a fault in the bleed air system 10 may be predicted when the comparison indicates that the sensor satisfies a predetermined threshold. The term “satisfies” the threshold is used herein to mean that the variation comparison satisfies the predetermined threshold, such as being equal to, less than, or greater than the threshold value. It will be understood that such a determination may easily be altered to be satisfied by a positive/negative comparison or a true/false comparison. For example, a less than threshold value can easily be satisfied by applying a greater than test when the data is numerically inverted. Any number of faults in the bleed air system 10 may be determined By way of non-limiting example, a change in the relationship of the fan speed and the pre-cooler outlet temperature may be determined If there is a change outside an expected range, then a fault with the pre-cooler control valve (PCCV) may be predicted. Further, a fault may be predicted with a PCCV when the comparisons indicate an increasing pre-cooler outlet temperature trend versus historic data and/or a shift in relationship between pre-cooler outlet temperature and fan speed and/or when there is a pneumatic pressure split between engines on the same aircraft. Further, a fault with a pressure regulating shutoff valve (PRSOV) or bleed air regulator may be predicted when fluctuating pressures are determined, a fault with a high stage regulator or high stage valve may be predicted when a low pressure is determined, however if this is only determined in climb or cruise a fault with the air regulation system may be determined, a fault with the high stage regulator or high stage valve may be predicted when the fan speed is determined to be low and a low pressure is determined, a fault with the bleed air regulator or PRSOV may be determined when the fan speed is determined to be high and the pressure is determined to be high, a fault with the high stage regulator or high stage valve may be determined when the engines were determined to be at high power and pressure upstream of the PRSOV is determined to be high. Sensor faults may also be determined by determining a high number of out of range readings or for example via comparisons of recent median temperatures to historic median temperature where other readings were determined to be normal. It will be understood that any number of faults may predicted based on any number of comparisons. These comparisons may also be used to provide information relating to the severity of the fault and likely time to failure.

In implementation, the reference values for the sensor output and comparisons may be converted to an algorithm to predict faults in the bleed air system 10. Such an algorithm may be converted to a computer program comprising a set of executable instructions, which may be executed by the controller 40 and/or the computer 50. Various other parameters recorded by onboard systems such as altitude, valve settings, etc. may also be utilized by such a computer program to predict faults in the bleed air system 10. Alternatively, the computer program may include a model, which may be used to predict faults in the bleed air system 10. For example, a subset of data where the data is known to be free of significant variation from normal expected performance and having no known maintenance issues may be used to train a prediction model. The overall model may generate a number of outputs including a likelihood of failure score. A threshold may be applied to this likelihood score and if exceeded an indication may be provided. An indication may also be provided if either the maximum temperature over a given number of flights exceeds a value close to that at which the system trips out or if the pressure difference is recorded to be significant or a pressure reading exceeds a high/low threshold. For example, the high/low threshold may be set a distance above and below the pressure the system regulates the pressure between (e.g. if the system is regulated between 35 and 45 PSI, then the high threshold may be 50 PSI and the low threshold may be 20 PSI).

At 108, the controller 40 and/or the computer 50 may provide an indication of the fault in the bleed air system 10 predicted at 106. The indication may be provided in any suitable manner at any suitable location including in the cockpit 34 and at the ground system 52. For example, the indication may be provided on a primary flight display (PFD) in a cockpit 34 of the aircraft 30. If the controller 40 ran the program, then the suitable indication may be provided on the aircraft 30 and/or may be uploaded to the ground system 52. Alternatively, if the computer 50 ran the program, then the indication may be uploaded or otherwise relayed to the aircraft 30. Alternatively, the indication may be relayed such that it may be provided at another location such as an airline control or flight operations department.

It will be understood that the method of predicting a bleed air system fault is flexible and the method illustrated is merely for illustrative purposes. For example, the sequence of steps depicted is for illustrative purposes only, and is not meant to limit the method 100 in any way as it is understood that the steps may proceed in a different logical order or additional or intervening steps may be included without detracting from embodiments of the invention. By way of non-limiting example, predicting the fault may be based on multiple comparisons. More specifically, the fault may be predicted when the comparison exceeds a reference value a predetermined number of times over a predetermined number of flights. Further, the fault may be based on derived data such as medians, minima, maximum values, standard deviations, counts above or below thresholds, change of state, etc. that may be calculated per phases of the flight of the aircraft.

Technical effects of the above described embodiments include that data gathered by the aircraft may be utilized to predict a bleed air system fault. This allows such predicted faults to be corrected before they occur. Currently there is no manner to predict the fault of a bleed air system. The above described embodiments allows for automatic predicting and alerting to users of faults. The above embodiments allow accurate predictions to be made regarding the bleed air system faults. By predicting such problems sufficient time may be allowed to make repairs before such faults occur. This allows for cost savings by reducing maintenance cost, rescheduling cost, and minimizing operational impacts including minimizing the time aircraft are grounded.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of predicting a bleed air system fault in an aircraft having an engine operably coupled to a bleed air system including at least one valve, at least one bleed air system sensor, the method comprising:
receiving a sensor signal from the at least one of the bleed air system sensor to define a sensor output;
comparing the sensor output to a reference value for the sensor output;
predicting a fault in the bleed air system based on the comparison; and
providing an indication of the predicted fault.

2. The method of claim 1 wherein the sensor output is received once per flight.

3. The method of claim 1 wherein the defined sensor output is aggregated over time to define aggregated sensor data, and the comparison comprises comparing the aggregated sensor data to the reference value.

4. The method of claim 3 wherein the aggregating the sensor output over time comprises aggregating the sensor output over multiple flights.

5. The method of claim 4 wherein the aggregated sensor data comprises a median value, a running median value, or a historical median value.

6. The method of claim 4 wherein the aggregated sensor data comprises a current median value and a historical median value.

7. The method of claim 6 wherein the comparison comprises the aggregated sensor output satisfying a threshold value.

8. The method of claim 6 wherein the aggregated sensor data is reset after a maintenance event.

9. The method of claim 1 wherein providing the indication comprises providing the indication on a PFD in a cockpit of the aircraft.

10. The method of claim 1 wherein receiving the sensor signal further comprises receiving a temperature sensor output from a temperature sensor.

11. The method of claim 10 wherein receiving the sensor signal further comprises receiving a fan speed output indicative of a fan speed of the engine.

12. The method of claim 11 wherein the reference value is indicative of a temperature or pressure value at a specific fan speed.

13. The method of claim 1 wherein receiving the sensor signal further comprises receiving a pressure sensor output indicative of the air pressure of the bleed air system.

14. The method of claim 13 wherein the reference value is a pressure calculated from another engine of the aircraft.

15. The method of claim 1 wherein the sensor output is from multiple phases of flight of the aircraft.

16. The method of claim 15 wherein the multiple phases of flight include taxi and cruise.

17. The method of claim 16 wherein the sensor output is one of a median sensor output calculated from sensor output received from the multiple phases.

18. The method of claim 1 wherein the predicting the fault is based on multiple comparisons.

19. The method of claim 18 wherein the fault is predicted when the comparison exceeds the reference value a predetermined number of times over a predetermined number of flights.

20. The method of claim 1 wherein a controller of the aircraft receives the sensor signal, compares the sensor output, predicts the fault, and provides the indication.
